(19) United States
(12) Patent Application Publication
(10) Pub. No.: US 2009/0087721 A1
(43) Pub. Date: Apr. 2, 2009

(54) SURFACE-MODIFIED CARBON MATERIAL AND METHOD FOR PRODUCING THE SAME

(76) Inventors: Kenta YOSHIDA, Shizuoka (JP); Hirotaka Kitagawa, Kanagawa (JP); Yoshio Inagaki, Kanagawa (JP)

Correspondence Address: BIRCH STEWART KOLASCH & BIRCH, PO BOX 747, FALLS CHURCH, VA, 22040-0747, US

(21) Appl. No.: 12/235,245

(22) Filed: Sep. 22, 2008

(30) Foreign Application Priority Data
Sep. 28, 2007 (JP) 2007-253377

(51) Int. Cl. H01M 8/02; H01M 4/90; C07F 7/08; B01J 31/02

(52) U.S. Cl. 429/43; 502/158; 556/428

(57) ABSTRACT

Disclosed is a surface-modified carbon material obtained by subjecting a carbon material to react with a benzyne. The surface-modified carbon material has high heat stability.

### FIELD OF THE INVENTION

The present invention relates to a surface-modified carbon material and a method for producing the same. In particular, the invention relates to a novel surface-modified carbon material having an organic group bounded to the carbon material, obtained through a reaction of a benzyne with the carbon material. Also, the invention relates to a catalyst-supported carbon material, a membrane and electrode assembly and a fuel cell, and a rubber compound each using the subject surface-modified carbon material.

### BACKGROUND OF THE INVENTION

Carbon includes various allotropes exist and is used variously in accordance with its use. So-called active carbon having a large surface area is used for an adsorbing material, a noble metal catalyst carrier, a catalyst carrier for fuel cell, a rubber compound for tire, etc., and in order to conform to various applications, carbon materials having a functional group of every kind introduced on the surface thereof are used. So far, various studies have been made for the purpose of improving surface properties of a carbon material through surface modification. Though modification by physical adsorption onto the surface of a carbon material is possible, it is difficult to achieve firm modification so as to form a chemical bond.

Some methods for improving surface properties of a carbon material are already known, a part of which has been commercially utilized. For example, it is widely known that the surface of carbon black which is one sort of the carbon material is oxidized through a treatment with an oxidizing agent of every kind. Also, it is known that the surface of carbon black can be sulfonated or halogenated by using sulfuric acid or chlorosulfuric acid. A method for grafting a polymer on the carbon black surface is surveyed in Tsubokawa, Polym. Sci., Vol. 17, pages 417 to 470 (1992). Furthermore, JP-A-2006-199968 discloses that the surface modification of carbon black is possible by using a diazonium salt.

Moreover, in recent years, the surface modification of a carbon nanotube is reported and surveyed in Chem. Rev., Vol. 106, pages 1105 to 1136 (2006).

### SUMMARY OF THE INVENTION

However, the surface-modified carbon materials produced by the foregoing methods are low in heat stability so that they involved a problem of use in a noble metal catalyst carrier for chemical industry and a catalyst carrier for fuel cell, which are used at a high temperature, and a rubber compound for tire, which requires high durability.

In order to solve the foregoing problems, the invention has been made, and its object is to provide a carbon material, of which properties are improved by modifying the surface thereof.

Under these circumstances, the present inventors made extensive and intensive investigations. As a result, it has been found that the foregoing problems can be solved by the following measures, leading to accomplishment of the invention.
(1) A surface-modified carbon material, wherein a value obtained by dividing a weight loss (% by mass) by a specific surface area (m²/g) of the carbon material is not more than 1.5×10⁻³, the weight loss being a value when the temperature is raised from 150 to 250° C. at a rate of 10° C./min in a nitrogen gas atmosphere having a purity of 99.99% or more.
(2) A surface-modified carbon material obtained by subjecting a carbon material to react with a benzyne.
(3) The surface-modified carbon material as set forth in (2), wherein a value obtained by dividing a weight loss (% by mass) by a specific surface area (m²/g) of the carbon material is not more than 1.5×10⁻³, the weight loss being a value when the temperature is raised from 150 to 250° C. at a rate of 10° C./min in a nitrogen gas atmosphere having a purity of 99.99% or more.
(4) The surface-modified carbon material as set forth in (2), wherein a value obtained by dividing a weight loss (% by mass) by a specific surface area (m²/g) of the carbon material is not more than 1.2×10⁻³, the weight loss being a value when the temperature is raised from 150 to 250° C. at a rate of 10° C./min in a nitrogen gas atmosphere having a purity of 99.99% or more.
(5) The surface-modified carbon material as set forth in any one of (2) to (4), wherein the benzyne is a compound represented by the following general formula (1).

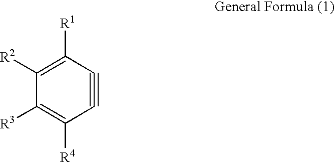

In the general formula (1), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; and X⁻ is a halide ion or an anion derived from a mineral acid or an organic acid.
(6) The surface-modified carbon material as set forth in any one of (2) to (5), wherein the benzyne is a compound generated from, as a precursor, a compound represented by the following general formula (2).

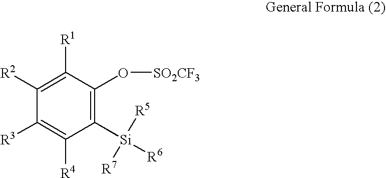

In the general formula (2), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; X⁻ is a halide ion or an anion derived from a mineral acid or an organic acid; and R⁵, R⁶ and R⁷, which may be the same or different, are each a hydrogen atom, an alkyl group, an alkenyl group, an alkynyl group, an aryl group, a heteroaryl group or an aralkyl group.
(7) The surface-modified carbon material as set forth in any one of (2) to (6), which comprises an organic group derived from the benzyne in amount of 0.1 mmoles or more per 1 g of the surface-modified carbon material.
(8) The surface-modified carbon material as set forth in any one of (2) to (6), which comprises an organic group derived from the benzyne in amount of from 0.2 to 5.0 mmoles per 1 g of the surface-modified carbon material.
(9) The surface-modified carbon material as set forth in any one of (1) to (8), wherein the carbon material is carbon black or carbon nanotube.
(10) The surface-modified carbon material as set forth in any one of (1) to (8), wherein the carbon material is carbon black.
(11) The surface-modified carbon material as set forth in any one of (1) to (10), wherein the specific surface area of the carbon material is from 20 to 1,000 m²/g.
(12) The surface-modified carbon material as set forth in any one of (1) to (10), wherein the specific surface area of the carbon material is from 60 to 800 m²/g.
(13) A method for producing a surface-modified carbon material comprising subjecting a carbon material to react with a compound represented by the following general formula (1).

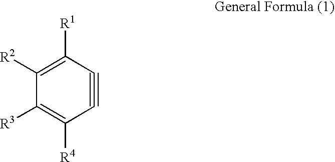

In the general formula (1), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; and X⁻ is a halide ion or an anion derived from a mineral acid or an organic acid.
(14) The method for producing a surface-modified carbon material as set forth in (13), wherein a fluoride ion is exerted on a compound represented by the following general formula (2) to generate the compound represented by the general formula (1).

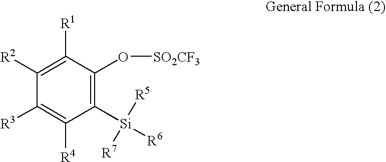

In the general formula (2), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; X⁻ is a halide ion or an anion derived from a mineral acid or an organic acid; and R⁵, R⁶ and R⁷, which may be the same or different, are each a hydrogen atom, an alkyl group, an alkenyl group, an alkynyl group, an aryl group, a heteroaryl group or an aralkyl group.
(15) The method for producing a surface-modified carbon material as set forth in (13) or (14), wherein the surface-modified carbon material is the surface-modified carbon material as set forth in any one of (1) to (12).
(16) A catalyst-supported carbon material comprising a metal catalyst supported on the surface-modified carbon material as set forth in any one of (1) to (12).
(17) The catalyst-supported carbon material as set forth in (16), wherein the metal catalyst is platinum.
(18) A membrane and electrode assembly comprising a porous conductive sheet and a catalyst layer provided in contact with the porous conductive sheet, the catalyst layer containing the catalyst-supported carbon material as set forth in (16) or (17).
(19) A fuel cell comprising the membrane and electrode assembly as set forth in (18).
(20) A rubber compound comprising the surface-modified carbon material as set forth in any one of (1) to (12).

According to the invention, it has become possible to provide a surface-modified carbon material having high heat stability. For that reason, it has become possible to widely utilize the surface-modified carbon material for an application of use at a high temperature and an application requiring high durability.

### BRIEF DESCRIPTION OF THE DRAWINGS

FIG. 1 is a diagrammatic cross-sectional view showing a configuration of a membrane and electrode assembly of the invention.

FIG. 2 is a diagrammatic cross-sectional view showing one example of a structure of a fuel cell of the invention.

### DESCRIPTION OF SPECIFIC EMBODIMENTS

The contents of the invention are hereunder described in detail. In this specification, numerical value ranges expressed by the term “to” mean that the numerical values described before and after it are included as a lower limit and an upper limit, respectively. Also, in the invention, various physical property values are those in a state at room temperature (for example, 25° C.) unless otherwise indicated.

In the surface-modified carbon material of the invention, a value obtained by dividing a weight loss (% by mass) , when the temperature is raised from 150 to 250° C. at a rate of 10° C./min in a nitrogen gas atmosphere having a purity of 99.99% or more, by a specific surface area (m²/g) of the carbon material is preferably not more than 1.5×10⁻³, more preferably not more than 1.2×10⁻³, and especially preferably not more than 1.0×10⁻³.

The surface-modified carbon material of the invention is preferably a carbon material obtained through surface modification by subjecting a carbon material to react with a benzyne. Here, in the surface-modified carbon material of the invention, an organic group derived from the benzyne is bonded preferably in an amount of 0.1 mmoles or more, and more preferably in an amount of from 0.2 to 5.0 mmoles per 1 g of the surface-modified carbon material. As a method for generating the benzyne which can be used in the invention, for example, known methods such as a method for thermally decomposing or photo-decomposing a diazonium salt obtained from anthranilic acid and an alkyl nitrite (see, for example L. Friedman, J. Am. Chem. Soc., Vol. 89, pages 3071 to 3073 (1967)); a method for exerting metallic magnesium on o-fluorobromobenzene (see, for example, M. E. Kuehne, J. Am. Chem. Soc., Vol. 84, pages 837 to 847 (1962)); and a method for exerting a fluoride ion on trifluoromethanesulfonic acid 2-(trimethylsilyl)benzene (see, for example, Y. Himeshima, T. Sonoda, H. Kobayashi, Chem. Lett., pages 1211 to 1214 (1983)) can be employed.

In the invention, in particular, a method for generating a benzyne by using, as a precursor, a compound represented by the general formula (2) as described later, such as trifluoromethanesulfonic acid 2-(trimethylsilyl)benzene is preferable; and a method for exerting a fluoride ion on a compound represented by the general formula (2) is more preferable.

The benzyne to be used in the invention is preferably a compound represented by the following general formula (1)

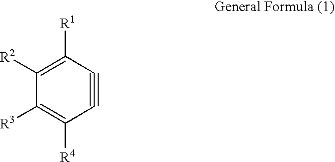

In the general formula (1), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; and X⁻ is a halide ion or an anion derived from a mineral acid or an organic acid.

In the general formula (1), as to the groups represented by R¹, R², R³ and R⁴, of the foregoing groups, groups having not more than 20 carbon atoms are preferable; and a carboxylate salt, a sulfonic acid salt, —PO₃H₂, a monobasic phosphonic acid salt, a dibasic phosphonic acid salt, —N₂⁺X⁻, —NR₃⁺X⁻ and —PR₃^{|}X⁻ are preferable because they are a comparatively hydrophilic group.

In the general formula (1), the alkyl group represented by R and R′ is preferably a linear, branched or cyclic alkyl group having from 1 to 20 carbon atoms and may have a substituent. This substituent is preferably a group selected from the same range as in the definition of R¹, R², R³ and R⁴. The alkyl group is especially preferably a group having not more than 10 carbon atoms.

In the general formula (1), the alkenyl group represented by R and R′ is preferably a linear, branched or cyclic alkenyl group having from 2 to 20 carbon atoms and may have a substituent. This substituent is preferably a group selected from the same range as in the definition of R¹, R², R³ and R⁴. The alkenyl group is especially preferably a group having not more than 10 carbon atoms.

In the general formula (1), the alkynyl group represented by R and R′ is preferably a linear, branched or cyclic alkynyl group having from 2 to 20 carbon atoms and may have a substituent. This substituent is preferably a group selected from the same range as in the definition of R¹, R², R³ and R⁴. The alkynyl group is especially preferably a group having not more than 10 carbon atoms.

In the general formula (1), the aryl group represented by R and R′ is preferably an aryl group having from 6 to 20 carbon atoms and may have a substituent. This substituent is preferably a group selected from the same range as in the definition of R¹, R², R³ and R⁴. The aryl group is especially preferably a group having not more than 10 carbon atoms.

In the general formula (1), the heteroaryl group represented by R and R′ is preferably a heteroaryl group having from 1 to 20 carbon atoms and may have a substituent. This substituent is preferably a group selected from the same range as in the definition of R¹, R², R³ and R⁴. The heteroaryl group is especially preferably a group having not more than 10 carbon atoms.

In the general formula (1), the aralkyl group represented by R and R′ is preferably a linear, branched or cyclic aralkyl group having from 7 to20 carbon atoms and may have a substituent. This substituent is preferably a group selected from the same range as in the definition of R¹, R², R³ and R⁴. The aralkyl group is especially preferably a group having not more than 10 carbon atoms.

In the general formula (1), the halide ion represented by X⁻ is preferably Cl⁻, Br⁻ or I⁻; and the anion derived from a mineral acid or an organic acid is preferably a monovalent anion, a divalent anion and a trivalent anion (for example, BF₄⁻, PF₆⁻, SbF₆⁻, ClO₄⁻, a methanesulfonic acid ion, a p-toluenesulfonic acid ion, a naphthalene-1,5-disulfonic acid ion, a benzoic acid ion, an oxalic acid ion, a phosphoric acid ion, a monohydrogenphosphate ion, a dihydrogenphosphate ion, an isothiocyanic acid ion, an isocyanic acid ion, a sulfuric acid ion and a hydrogensulfate ion). X⁻ is more preferably Cl⁻, Br⁻, I⁻, a sulfuric acid ion or a phosphoric acid ion.

As described previously, the surface-modified carbon material of the invention is preferably produced by a method for exerting a fluoride ion on the compound represented by the general formula (2).

Here, though a generation source of the fluoride ion is not particularly defined, for example, alkali metal salts, alkaline earth metal salts, ammonium salts and the like are useful. Of these, potassium fluoride and cesium fluoride are more preferable; and cesium fluoride is especially preferable. A completing agent such as crown ethers may also be added.

Then, the compound represented by the general formula (2) is described.

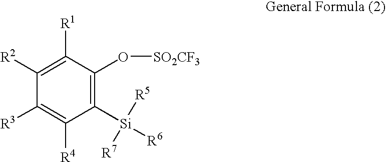

In the general formula (2), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR^{|}₃X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; X⁻ is a halide ion or an anion derived from a mineral acid or an organic acid; and R⁵, R⁶ and R⁷, which may be the same or different, are each a hydrogen atom, an alkyl group, an alkenyl group, an alkynyl group, an aryl group, a heteroaryl group or an aralkyl group.

In the general formula (2), as to the groups represented by R¹, R², R³ and R⁴, of the foregoing groups, groups having not more than 20 carbon atoms are preferable; and a carboxylate salt, a sulfonic acid salt, —PO₃H₂, a monobasic phosphonic acid salt, a dibasic phosphonic acid salt, —N₂⁺X⁻, —NR₃⁺X⁻ and —PR₃⁺X⁻ are especially preferable because they are a comparatively hydrophilic group.

In the general formula (2), the alkyl group represented by R and R′ is preferably a linear, branched or cyclic alkyl group having from 1 to 20 carbon atoms and may have a substituent. This substituent is preferably a group selected from the same range as in the definition of R¹, R², R³ and R⁴. The alkyl group is especially preferably a group having not more than 10 carbon atoms.

In the general formula (2), the alkenyl group represented by R and R′ is preferably a linear, branched or cyclic alkenyl group having from 2 to 20 carbon atoms and may have a substituent. This substituent is preferably a group selected from the same range as in the definition of R¹, R², R³ and R⁴. The alkenyl group is especially preferably a group having not more than 10 carbon atoms.

In the general formula (2), the alkynyl group represented by R and R′ is preferably a linear, branched or cyclic alkynyl group having from 2 to 20 carbon atoms and may have a substituent. This substituent is preferably a group selected from the same range as in the definition of R¹, R², R³ and R⁴. The alkynyl group is especially preferably a group having not more than 10 carbon atoms.

In the general formula (2), the aryl group represented by R and R′ is preferably an aryl group having from 6 to 20 carbon atoms and may have a substituent. This substituent is preferably a group selected from the same range as in the definition of R¹, R², R³ and R⁴. The aryl group is especially preferably a group having not more than 10 carbon atoms.

In the general formula (2), the heteroaryl group represented by R and R′ is preferably a heteroaryl group having from 1 to 20 carbon atoms and may have a substituent. This substituent is preferably a group selected from the same range as in the definition of R¹, R², R³ and R⁴. The heteroaryl group is especially preferably a group having not more than 10 carbon atoms.

In the general formula (2), the aralkyl group represented by R and R′ is preferably a linear, branched or cyclic aralkyl group having from 7 to 20 carbon atoms and may have a substituent. This substituent is preferably a group selected from the same range as in the definition of R¹, R², R³ and R⁴. The aralkyl group is especially preferably a group having not more than 10 carbon atoms.

In the general formula (2), the halide ion represented by X⁻ is preferably Cl⁻, Br⁻ or I⁻; and the anion derived from a mineral acid or an organic acid is preferably a monovalent anion, a divalent anion, and a trivalent anion (for example, BF₄⁻, PF₆⁻, SbF₆⁻, ClO₄⁻, a methanesulfonic acid ion, a p-toluenesulfonic acid ion, a naphthalene-1,5-disulfonic acid ion, a benzoic acid ion, an oxalic acid ion, a phosphoric acid ion, a monohydrogenphosphate ion, a dihydrogenphosphate ion, an isothiocyanic acid ion, an isocyanic acid ion, a sulfuric acid ion and a hydrogensulfate ion). X⁻ is more preferably Cl⁻, Br⁻, I⁻, a sulfuric acid ion or a phosphoric acid ion.

In the general formula (2), the alkyl group represented by R⁵, R⁶ and R⁷ is preferably a linear, branched or cyclic alkyl group having from 1 to 20 carbon atoms and may have a substituent. This substituent is preferably a group selected from the same range as in the definition of R¹, R², R³ and R⁴. The alkyl group is especially preferably a group having not more than 10 carbon atoms.

In the general formula (2), the alkenyl group represented by R⁵, R⁶ and R⁷ is preferably a linear, branched or cyclic alkenyl group having from 2 to 20 carbon atoms and may have a substituent. This substituent is preferably a group selected from the same range as in the definition of R¹, R², R³ and R⁴. The alkenyl group is especially preferably a group having not more than 10 carbon atoms.

In the general formula (2), the alkynyl group represented by R⁵, R⁶ and R⁷ is preferably a linear, branched or cyclic alkynyl group having from 2 to 20 carbon atoms and may have a substituent. This substituent is preferably a group selected from the same range as in the definition of R¹, R², R³ and R⁴. The alkynyl group is especially preferably a group having not more than 10 carbon atoms.

In the general formula (2), the aryl group represented by R⁵, R⁶ and R⁷ is preferably an aryl group having from 6 to 20 carbon atoms and may have a substituent. This substituent is preferably a group selected from the same range as in the definition of R¹, R², R³ and R⁴. The aryl group is especially preferably a group having not more than 10 carbon atoms.

In the general formula (2), the heteroaryl group represented by R⁵, R⁶ and R⁷ is preferably a heteroaryl group having from 1 to 20 carbon atoms and may have a substituent. This substituent is preferably a group selected from the same range as in the definition of R¹, R², R³ and R⁴. The heteroaryl group is especially preferably a group having not more than 10 carbon atoms.

In the general formula (2), the aralkyl group represented by R⁵, R⁶ and R⁷ is preferably a linear, branched or cyclic aralkyl group having from 7 to 20 carbon atoms and may have a substituent. This substituent is preferably a group selected from the same range as in the definition of R¹, R², R³ and R⁴. The aralkyl group is especially preferably a group having not more than 10 carbon atoms.

In the method for exerting a fluoride ion on the compound represented by the general formula (2), though a reaction solvent thereof is not particularly defined, examples of the solvent which can be used include 1,2-dimethoxyethane, bis(2-methoxyethyl) ether, 1,2-bis(2-methoxyethyl)ethane, tetrahydrofuran, bis[2-(2-methoxyethoxy)ethyl] ether, 1,4-dioxane, benzene, toluene, o-xylene, m-xylene, p-xylene, chlorobenzene, o-dichlorobenzene, m-dichlorobenzene, p-dichlorobenzene, bromobenzene, o-dibromobenzene, m-dibromobenzene, p-dibromobenzene, o-chlorotoluene, m-chlorotoluene, p-chlorotoluene, o-bromotoluene, m-bromotoluene, p-bromotoluene, tetrachloroethane, dichloroethane, chloroform, methylene chloride, carbon tetrachloride, acetonitrile and benzonitrile. Of these, 1,2-dimethoxyethane, bis(2-methoxyethyl) ether, 1,2-bis(2-methoxyethoxy)ethane, tetrahydrofuran, bis[2-(2-methoxyethyl)ethyl] ether, 1,4-dioxane, acetonitrile and benzonitrile are more preferable; and acetonitrile is further preferable. Two or more of these solvents may be mixed in an arbitrary amount and used.

The reaction temperature, reaction time and reaction pressure are not particularly limited, and known conditions can be applied. The reaction temperature is preferably from 0 to 100° C., and more preferably from 20 to 80° C. Also, though the reaction time varies according to the kind of the benzyne precursor to be used, the kind of the fluoride ion generation source, the kind of the solvent and the reaction temperature, it is preferably from 1 to 24 hours, more preferably from 3 hours to 18 hours, and further preferably from 5 hours to 12 hours. The reaction pressure may be carried out under pressurized pressure or reduced pressure, and may be carried out under atmospheric pressure.

The carbon material to be modified in the invention is not particularly defined, and known carbon materials other than fullerenes can be used. Examples thereof include carbon black, carbon nanotube (CNT) and carbon nanohorn (CNH). Carbon black and carbon nanotube have high conductivity and therefore, can be especially preferably used as a catalyst carrier for fuel cell. As the carbon material, only a single kind may be used, or a mixture of two or more kinds may be used.

A specific surface area of the carbon material is preferably from 20 to 1,000 m²/g, and more preferably from 60 to 800 m²/g.

### Carbon Black

The carbon black to be used in the invention is, in general, a fine powder formed by vapor phase thermal decomposition or imperfect combustion of a natural gas or a hydrocarbon gas and is spherical or chain carbon. The carbon black includes channel black, furnace black, thermal black and lamp black depending upon the production method. These are different in particle size, oxygen content, volatile component, specific surface area, micro structure and the like and are described in Newest Carbon Black Technology Complete Collection, Chapter 4 (2005, Technical Information Institute Co., Ltd.). Commercially available products such as ketjen black and Vulcan XC-72 can also be used.

In the case where the surface-modified carbon material of the invention is used as a noble metal catalyst carrier for chemical synthesis or a catalyst carrier for fuel cell, it is preferable that the carbon black contains an acid group or a salt of acid group which is able to mutually act on a noble metal catalyst. For example, the following can be exemplified, but it should not be construed that the invention is limited thereto.

### Acid Group or Salt of Acid Group

A carboxylate salt, for example, —COOLi, —COONa, —COOK, —COO⁻NR₄⁺, —SO₃H; a sulfonic acid salts, for example, —SO₃Li, —SO₃Na, —SO₃K, —SO₃⁻NR₄⁺, —OSO₃H, an —OSO₃⁻ salt; —PO₃H₂; a phosphonic acid salt, for example, —PO₃HNa, —PO₃Na₂; a phosphoric acid salt, for example, —OPO₃HNa, —OPO₃Na₂; —SSO₃H; and an —SSO₃⁻ salt

Here, R is a hydrogen atom, a branched or linear, substituted or unsubstituted hydrocarbon group having from 1 to 20 carbon atoms, for example, an alkyl group, an alkenyl group and an alkynyl group, a substituted or unsubstituted aryl group, a substituted or unsubstituted heteroaryl group or a substituted or unsubstituted aralkyl group.

The surface-modified carbon material of the invention can be preferably used as a carrier of the catalyst metal such as a platinum particle. Examples of a method for supporting the catalyst metal include a heat reduction method, a sputtering method, a pulse laser deposition method and a vacuum vapor deposition method. For example, WO 2002/054514 can be made hereof by reference.

In the invention, examples of a method for preparing the catalyst-supported carbon material include a method in which a functional group is introduced into a carbon material, and a catalyst metal is then supported; and a method in which a catalyst metal is supported on a carbon material, and a functional is then introduced, and all of these methods can be favorably used. The catalyst-supported carbon material can also be obtained by introducing a functional group into a commercially available catalyst-supported carbon material (for example, platinum-supported ketjen black, manufactured by Tanaka Kikinzoku Kogyo K.K.; or platinum-supported XC-72, manufactured by E-TEK).

In the case where a catalyst metal is supported on a carbon material, and a functional group is then introduced, or in the case where a functional group is introduced into a commercially available catalyst-supported carbon material, in view of safety, it is preferable that the reaction is carried out under an oxygen-free condition, the reaction is carried out in a flame-retardant solvent, or a flame retarder is added in the reaction system. As a method for carrying out the reaction under an oxygen-free condition, a method for carrying out the reaction in an inert gas atmosphere is exemplified. Examples of the inert gas to be used include helium, argon, neon and nitrogen, with argon and nitrogen being especially preferable.

Examples of the flame-retardant solvent include dichloromethane, chloroform, carbon tetrachloride, 1,1,1-trichloroethane, 1,1,2-trichloroethane, 1,1,1,2-tetrachloroethane, 1,1,2,2-tetrachloroethane and water. Taking into consideration the solubility of a reaction reagent, the reaction temperature, the boiling point of the solvent, etc., these flame retardant solvents are properly chosen and used. These solvents may be used singly, or a mixture of plural kinds thereof may be used.

As the flame retardant, phosphoric ester based flame retardants, for example, hexamethyl phosphoramide, trimethyl phosphate, triethyl phosphate, tricresyl phosphate, trixylenyl phosphate, cresyldiphenyl phosphate, bisphenol A bis(diphenyl)phosphate, hydroquinol bis(diphenyl)phosphate, phenyldixylenyl phosphate, xylenyldiphenyl phosphate, resorcinol bis(diphenyl)phosphate and 2-ethylhexyldiphenyl phosphate are exemplified as preferred examples. These flame retardants may be used singly, or a mixture of plural kinds thereof may be used. A proportion of such a flame retardant to be added is preferably 5% or more, more preferably 10% or more, and especially preferably 15% or more relative to the reaction solvent. Of the foregoing flame retardants, those which are liquid may be used as the reaction solvent.

The carbon material of the invention can be used for an electrode for fuel cell, a membrane and electrode assembly (hereinafter referred to as “MEA”) and a fuel cell using the subject membrane and electrode assembly.

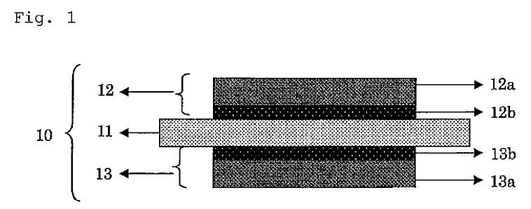

FIG. 1 shows one example of a diagrammatic cross-sectional view showing the membrane and electrode assembly of the invention. MEA 10 is provided with a polymer electrolyte membrane 11 in a film form and an anode electrode 12 and a cathode electrode 13 interposing the polymer electrolyte membrane 11 therebetween and opposing to each other. Examples of the polymer electrolyte membrane as referred to herein include perfluorocarbon sulfonic acid polymers represented by NAFION (a registered trademark); poly(meth)acrylates having a phosphoric acid group in a side chain thereof; sulfonated polyetheretherketone; sulfonated polyetherketone; sulfonated polyethersulfone; sulfonated polysulfone; heat-resistant aromatic polymers such as sulfonated polybenzimidazole; sulfonated polystyrene, sulfonated polyoxetane; sulfonated polyimides; sulfonated polyphenylene sulfide; sulfonated polyphenylene oxide; and sulfonated polyphenylene.

The anode electrodes 12 and the cathode electrode 13 are composed of porous conductive sheers (for example, carbon paper) 12a and 13a and catalyst layers 12b and 13b, respectively. The catalyst layers 12b and 13b are composed of a dispersion prepared by dispersing the surface-modified carbon material having a catalyst metal such as a platinum particle supported thereon according to the invention into a polymer electrolyte. Here, platinum is preferable as the catalyst metal.

A method for preparing the electrode is described. A polymer electrolyte represented by NAFION is dissolved in a solvent and mixed with the surface-modified carbon material having a catalyst metal supported thereon according to the invention, followed by dispersing. Examples of the solvent to be used at that time include heterocyclic compounds (for example, 3-methyl-2-oxazolidinone and N-methylpyrrolidone); cyclic ethers (for example, dioxane and tetrahydrofuran); chain ethers (for example, diethyl ether, ethylene glycol dialkyl ethers, propylene glycol dialkyl ethers, polyethylene glycol dialkyl ethers and polypropylene glycol dialkyl ethers); alcohols (for example, methanol, ethanol, isopropanol, ethylene glycol monoalkyl ethers, propylene glycol monoalkyl ethers, polyethylene glycol monoalkyl ethers and polypropylene glycol monoalkyl ethers); polyhydric alcohols (for example, ethylene glycol, propylene glycol, polyethylene glycol, polypropylene glycol and glycerin); nitrile compounds (for example, acetonitrile, glutarodinitrile, methoxyacetonitrile, propionitrile and benzonitrile); non-polar solvents (for example, toluene and xylene); chlorine based solvents (for example, methylene chloride and ethylene chloride); amides (for example, N,N-dimethylformamide, N,N-dimethylacetamide and acetamide); and water. Of these, heterocyclic compounds, alcohols, polyhydric alcohols and amides are especially preferably used.

The dispersion may be carried out by stirring, and ultrasonic dispersion, a ball mill and the like may also be used. The resulting dispersion liquid may be coated by using a coating method such as a curtain coating, extrusion coating, roll coating, spin coating, dip coating, bar coating, spray coating, slide coating and print coating methods.

Coating of the dispersion liquid will be described. In a coating process, a film may be formed by extrusion molding, or casting or coating of the above-described dispersion liquid. A support in this case is not particularly restricted, and preferable examples thereof include a glass substrate, a metal substrate, a polymer film, a reflection board and the like. Examples of the polymer film include a film of cellulose-based polymers such as triacetyl cellulose (TAC), ester-based polymers such as polyethylene terephthalate (PET) and polyethylene naphthalate (PEN), fluorine-containing polymers such as polytrifluoroethylene (PTFE), and polyimide. The coating may be carried out according to the above-mentioned methods. In particular, use of a conductive porous material (carbon paper, carbon cloth) as the support makes direct manufacture of the catalyst electrode possible.

These operations may be carried out by a film-forming machine that uses rolls such as calendar rolls or cast rolls, or a T die, or press molding by a press machine may also be utilized. Further, a stretching process may be added to control the film thickness or improve film characteristics.

Drying temperature in the coating process relates to the drying speed, and can be selected in accordance with properties of the material. It is preferably −20° C. to 150° C., more preferable 20° C. to 120° C., and further preferably 50° C. to 100° C. A shorter drying time is preferable from the viewpoint of productivity, however, a too short time tends to easily generate such defects as bubbles or surface irregularity. Therefore, drying time of 1 minute to 48 hours is preferable, 5 minutes to 10 hours is more preferable, and 10 minutes to 5 hours is further preferable. Control of humidity is also important, and relative humidity (RH) is preferably 25 to 100%, and more preferably 50 to 95%.

The coating liquid in the coating process preferably contains a small amount of metal ions, and in particular, it contains a small amount of transition metal ions, especially an iron, nickel and cobalt ions. The content of transition metal ions is preferably 500 ppm or less, and more preferably 100 ppm or less. Therefore, solvents used in the aforementioned processes preferably contain these ions in a small amount, too.

Further, a surface treatment may be carried out after performing the coating process. As to the surface treatment, surface roughening, surface cutting, surface removing or surface coating may be performed, which may, in some cases, improve adherence with the solid electrolyte film or the porous conductive material.

The shape of the polymer electrolyte is preferably of a film form, and its thickness is preferably from 5 to 200 μm, and especially preferably from 10 to 100 μm.

For the purpose of bringing the catalyst layers 12b and 13b into intimate contact with the polymer electrolyte membrane 11, a method in which the catalyst layers 12b and 13b are coated on the porous conductive layer sheets 12a and 13a, respectively, followed by contact bonding on the polymer electrolyte membrane 11 by a hot pressing method (preferably at from 120 to 130° C. and from 2 to 100 kg/cm²), or a method in which the catalyst layers 12b and 13b are coated on an appropriate support and subjected to contact bonding while transferring onto the electrolyte membrane 11, followed by interposing between the porous conductive layers 12a and 13a is generally employed.

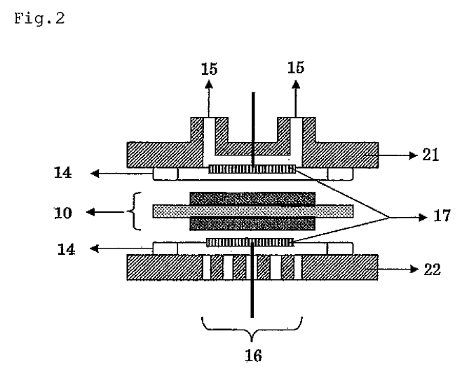

FIG. 2 shows one example of a structure of the fuel cell. The fuel cell has an MEA 10, a pair of separators 21 and 22 for interposing the MEA 10 therebetween, collectors 17 composed of a stainless steel net and installed in the separators 21 and 22 and packings 14. The separator 21 on the anode electrode side is provided with an opening 15 on the anode electrode side; and the separator 22 on the cathode electrode side is provided with an opening 16 on the cathode electrode side. A gas fuel such as hydrogen and an alcohol (for example, methanol) or a liquid fuel such as an alcohol aqueous solution is supplied from the opening 15 on the anode electrode side; and an oxidizing agent gas such as an oxygen gas and air is supplied from the opening 16 on the cathode electrode side.

For the anode electrode and the cathode electrode, a catalyst containing the catalyst-supported carbon material of the invention is preferably used. Here, a particle size of the active metal to be usually used for the catalyst is in the range of from 2 to 10 nm. When the particle size is small, since the surface area per unit mass is large, the activity increases, and therefore, such is advantageous. However, when the particle size is too small, it is difficult to disperse the active metal without agglomeration. Thus, it is said that its lower limit value is usually about 2 nm.

Activated polarization in a hydrogen-oxygen system fuel cell is greater for a cathode pole side (air pole side) compared with anode pole side (hydrogen pole side). This is because reaction at the cathode pole side (reduction of oxygen) is slower compared with that at the anode pole side. In order to enhance activity of the oxygen pole, various platinum-based bimetallic catalysts such as Pt—Cr, Pt—Ni, Pt—Co, Pt—Cu, Pt—Fe can be used. In a direct methanol fuel cell which employs a methanol aqueous solution as anode fuel, suppression of catalyst poisoning by CO is important. For this purpose, platinum-based bimetals such as Pt—Ru, Pt—Fe, Pt—Ni, Pt—Co and Pt—Mo, and platimum-based trimetals such as Pt—Ru—Mo, Pt—Ru'W, Pt—Ru—Co, Pt—Ru—Fe, Pt—Ru—Ni, Pt—Ru—Cu, Pt—Ru—Sn and Pt—Ru—Au can be used.

The surface-modified carbon material of the invention is preferably used as the carbon material for supporting an active metal thereon.

The functions of the catalyst layer are: (1) to transport the fuel to the active metal, (2) to provide a field for oxidation reaction (anode pole) and reduction reaction (cathode pole) of the fuel, (3) to transmit electrons generated by oxidation-reduction to the current collector, and (4) to transport protons generated by the reaction to the solid electrolyte. In order to accomplish (1), the catalyst layer must be porous to allow the liquid and gas fuels to permeate deeply. (2) is borne by the aforementioned active metal catalyst, and (3) is borne by the also aforementioned carbon material. In order to fulfill the function of (4), the catalyst layer is mixed with a proton conductive material.

The proton conductive material of the catalyst layer is not limited so far as it is a solid having a proton donating group. Polymer compounds having an acid residue which can be used in the polymer electrolyte membrane (for example, perfluorocarbon sulfonic acid polymers represented by NAFION; poly(meth)acrylates having a phosphoric acid group in a side chain thereof; sulfonated polyetheretherketone; and sulfonated compounds of a heat resistant aromatic polymer such as sulfonated polybenzimidazole) are preferably used. When a material of the same kind as in the polymer electrolyte membrane 11 is used, electrochemical adhesion between the polymer electrolyte membrane and the catalyst layer is enhanced, and such is more advantageous.

As to the use amount of the active metal catalyst, a range of from 0.03 to 10 mg/cm² is suitable from the viewpoints of cell output and economy. The amount of the conductive material for carrying the active metal catalyst is suitably from 1 to 10 times the mass of the active metal catalyst. As to the amount of the proton conductive material, a range of from 0.1 to 0.7 times relative to the weight of the carbon material for supporting an active metal thereon.

The conductive layer is also called an electrode substrate, a transmission layer or a backing layer, has a collection function and plays a role for preventing deterioration of the gas transmission to be caused due to gathering of water. In general, a material prepared by using carbon paper or a carbon cloth and treating it with polytetrafluoroethylene (PTFE) for the purpose of making it water-repellent can be used, too.

For manufacturing the MEA, following 4 methods are preferable.

(1) Proton conductive material coating method: wherein a catalyst paste (ink) containing an active platinum-supporitng carbon, a proton conductive material and a solvent as fundamental components is directly coated on both sides of the solid electrolyte, to which porous conductive sheets are thermal compression-bonded (hot pressed) to manufacture an MEA of 5-layer structure.

(2) Porous conductive sheet coating method: wherein the catalyst paste is coated on the surface of the porous conductive sheet to form a catalyst layer, followed by compression-bonding with the polymer electrolyte to manufacture an MEA of 5-layer structure.

(3) Decal method: wherein the catalyst paste is coated on a polytetrafluoroethylene (PTFE) sheet to form a catalyst layer, followed by transferring the catalyst layer alone to the polymer electrolyte to form a 3-layer MEA, to which a porous conductive sheet is pressure-bonded to manufacture an MEA of 5-layer structure.

(4) Later catalyst supporting method: wherein an ink, in which a carbon material not supporting platinum has been mixed with a proton conductive material, is coated on a polymer electrolyte, a porous conductive sheet or PTFE to form a film, followed by impregnating platinum ions into the polymer electrolyte and reducing the ion to precipitate a platinum powder in the film, thereby forming a catalyst layer. After the formation of the catalyst layer, an MEA is manufactured by the aforementioned methods (1) to (3).

As to the fuel which can be used for the fuel cell using the surface-modified carbon material of the invention, examples of an anode fuel include hydrogen, alcohols (for example, methanol, ethanol, isopropanol and ethylene glycol), ethers (for example, dimethyl ether, dimethoxymethane and trimethoxymethane), formic acid, boron hydride complexes and ascorbic acid; and of these, hydrogen and methanol are preferably used. Examples of a cathode fuel include oxygen (also including oxygen in the air) and hydrogen peroxide.

The method for supplying the foregoing anode fuel and cathode fuel into the respective catalyst layers includes two methods of (1) a method of forcedly circulating the fuel using an auxiliary machinery such as a pump (active type); and (2) a method not using an auxiliary machinery (for example, in case of a liquid, a capillary phenomenon or free drop; and in case of a gas, a passive type in which the catalyst layer is exposed to the air and the fuel is supplied). These methods can also be combined. Preferable is the active type in view of realization of a high output.

In general, single cell voltage of a fuel cell is 1.0 V or less, therefore, single cells are used in series stacking in accordance with necessary voltage required from load. As to the stacking method, there are 2 usable methods, that is, “planar stacking” wherein single cells are aligned on a plane and “bipolar stacking” wherein single cells are stacked via a separator having fuel paths formed on both sides thereof. The latter is suitable for a fuel cell because its thermal efficiency is high, and the resulting cell is compact. Besides, a method in which stacking is achieved by microfabrication on a silicon wafer while applying an MEMS technology is proposed, too.

As to the fuel cell, various utilizations for transportation, household, portable instrument, etc. may be considered. Examples of the utilization for transportation which can be favorably applied include vehicles (for example, a passenger car, a goods wagon, a two-wheeled vehicle and a personal vehicle); examples of the utilization for shipping or household include a cogeneration system, a vacuum cleaner and a robot; and examples of the utilization for portable instrument include a cellular phone, a laptop personal computer, an electronic still camera, PDA, a video camera and a portable video game player. Furthermore, the fuel cell can be used for a potable power generator, an outdoor lighting device, etc. Moreover, the fuel cell can be favorably used as a power source of an industrial or household robot or other toys. Moreover, the fuel cell is useful as a secondary battery mounted in such an instrument or a power source for charging a capacitor.

The surface-modified carbon material of the invention can be favorably used as a pigment, a filler or a reinforcing agent in blending and producing a rubber compound as in case of using known carbon materials. Properties of the carbon material are an important factor in determining the performance of a rubber compound containing the carbon material.

The carbon material is useful in the production of, for example, a rubber vulcanized production, e.g., a tire. In the production of a tire, it is generally desirable to utilize a carbon material capable of forming a tire having satisfactory abrasion resistance and hysteresis performance. Tread abrasion properties of a tire are related to the abrasion resistance. The larger the abrasion resistance, the longer the distance covered by a tire enduring without being abraded. The hysteresis of the rubber compound means a difference between energy to be added for deforming the rubber compound and energy left when the rubber compound gets back to the initial undeformed state. A tire having a lower hysteresis value reduces the rolling resistance, and therefore, it is able to reduce the fuel consumption of a motorcar utilizing that tire. Accordingly, it is especially desirable to obtain a surface-modified carbon material capable of imparting larger abrasion resistance and lower hysteresis to a tire.

The surface-modified carbon material of the invention is useful for both a natural rubber and a synthetic rubber or a mixture of a natural rubber and a synthetic rubber. A surface-modified carbon material containing an aromatic sulfide group as an organic group is preferable for this use. The aromatic sulfide group is represented by the formula: Ar(CH₂)_{q}Sₖ(CH₂)ᵣAr′ or A-(CH₂)_{q}Sₖ(CH₂)ᵣAr″. In the formulae, Ar and Ar′ are each independently a substituted or unsubstituted arylene or heteroarylene group; Ar″ is an aryl or heteroaryl group; k is an integer of from 1 to 8; and q and r are each an integer of from 0 to 4. The substituted aryl group includes a substituted alkylaryl group. The preferred arylene group includes a phenylene group, especially a p-phenylene group or a benzothiazolylene group. The preferred aryl group includes phenyl group, naphthyl group and benzothiazolyl group. The number of existing sulfur is defined by k and is preferably in the range of from 2 to 4. Especially preferred examples of the aromatic sulfide group include bis-p-(C₆H₄)—S₂—(C₆H₄)— and p-(C₆H₄)—S₂—(C₆H₅). The surface-modified carbon material of the invention can be used in a rubber compound to be cured with sulfur or peroxide.

The surface-modified carbon material of the invention can be mixed with a natural rubber or a synthetic rubber by a usual measure, for example, kneading. In general, by using the surface-modified carbon material in an amount in the range of from 10 to 250 parts by weight based on 100 parts by weight of each rubber, reinforcement of a meaningful degree can be imparted. However, it is preferable to use the surface-modified carbon material in an amount of from 20 to 100 parts by weight based on 100 parts by weight of the rubber; and it is especially preferable to use the surface-modified carbon material in an amount of from 40 to 80 parts by weight based on 100 parts by weight of the rubber.

The rubber which is favorable for the use together with the invention includes natural rubbers and derivatives thereof, for example, chlorinated rubbers. Also, the surface-modified carbon material of the invention can be used together with a synthetic rubber, for example, those described below.

Copolymers of from 10 to 70% by weight of styrene and from 90 to 30% by weight of butadiene, for example, a copolymer of 19 parts of styrene and 81 parts of butadiene, a copolymer of 30 parts of styrene and 70 parts of butadiene, a copolymer of 43 parts of styrene and 57 parts of butadiene and a copolymer of 50 parts of styrene and 50 parts of butadiene;

Polymers and copolymers of a conjugated diene, for example, polybutadiene, polyisoprene, polychloroprene and copolymers of such a diene and an ethylene group-containing monomer which is copolymerizable with the diene (for example, styrene, methylstyrene, chlorostyrene, acrylonitrile, 2-vinylpyridine, 5-methyl-2-vinylpyridine, 5-ethyl-2-vinylpyridine, 2-methyl-5-vinylpyridine, an alkyl-substituted acrylate, vinyl ketone, methyl isopropenyl ketone, methyl vinyl ether and an α-methylenecarboxylic acid and esters and amides thereof, e.g., acrylic acid and a dialkyl acrylamide); and

Copolymers of ethylene and other higher olefin, for example, propylene, 1-butene and 1-pentene.

Accordingly, the rubber compound of the invention contains an elastomer, a curing agent, a reinforcing filler, a coupling agent and optionally, various processing aids, oily extenders and decomposition preventives. In addition to the foregoing examples, the elastomer includes those described below. However, it should not be construed that the invention is limited thereto.

1,3-Butadiene, styrene, isoprene, isobutylene, 2,3-dimethyl-1,3-butadiene, acrylonitrile, ethylene, propylene and polymers produced from others (for example, homopolymers, copolymers and terpolymers).

It is preferable that such an elastomer has a glass transition point (Tg) as measured by DSC of from −120 to 0° C. Examples of such an elastomer include poly(butadiene), poly(styrene-co-butadiene) and poly(isoprene).

The surface-modified carbon material of the invention is advantageous in the point that it is possible to impart abrasion resistance and/or reduced hysteresis to the rubber compound containing it.

### EXAMPLES

The present invention will be described more specifically below based on Examples. The material, use amount, percentage, treatment content, treatment procedure and the like represented in Examples below can be arbitrarily changed as long as the change results in no deviation from the intent of the invention. Accordingly, the scope of the invention is not restricted to the specific examples represented below.

### Example 1

### Production of Surface-Modified Carbon Material (1) Using Benzyne:

A surface-modified carbon material (1) was produced using a benzyne. Specifically, trifluoromethanesulfonic acid 2-(trimethylsilyl)-4-chlorobenzene (2.77 g) synthesized according to Angew. Chem. Int. Ed., Vol. 37, pages 2659 to 2661 (1998) was dissolved in 100 mL of acetonitrile. To this solution, 1.00 g of ketjen black (EC600JD, manufactured by Lion Corporation) having a specific surface area of 800 m²/g and 2.54 g of cesium fluoride were added. This mixture was stirred at 80° C. for 8 hours; and a precipitate was collected by filtration, washed with water and acetone and then dried in vacuo to obtain 1.15 g of a surface-modified carbon material (1). As a result of analysis using fluorescent X-rays, it was revealed that the surface-modified carbon material (1) contained 3.9% of a chlorine atom. Accordingly, it was noted that a chlorophenyl group was contained in an amount of 1.09 mmoles per gram of the surface-modified carbon material.

### Example 2

### Production of Surface-Modified Carbon Material (2) Using Benzyne:

A surface-modified carbon material (2) was produced using a benzyne. Specifically, 2.77 g of trifluoromethanesulfonic acid 2-(trimethylsilyl)-4-chlorobenzene was dissolved in 100 mL of acetonitrile. To this solution, 1.00 g of DENKA BLACK (a 100% pressed product, manufactured by Denki Kakgaku Kogyo Kabushiki Kaisha) having a specific surface area of 66 m²/g and 2.54 g of cesium fluoride were added. This mixture was stirred at 80° C. for 8 hours; and a precipitate was collected by filtration, washed with water and acetone and then dried in vacuo to obtain 0.97 g of a surface-modified carbon material (2). As a result of analysis using fluorescent X-rays, it was revealed that the surface-modified carbon material (2) contained 0.75% of a chlorine atom. Accordingly, it was noted that a chlorophenyl group was contained in an amount of 0.21 mmoles per gram of the surface-modified carbon material.

### Comparative Example 1

### Production of Surface-Modified Carbon Material (3) Using Diazonium Salt:

5.31 g of 4-chloroaniline was dissolved in 50 mL of water and 20 mL of concentrated hydrochloric acid, and the solution was cooled to 2° C. while stirring. A solution prepared by dissolving 2.87 g of sodium nitrite in 10 mL of water was added dropwise thereto, and the mixture was stirred at not higher than 5° C. for one hour. 0.50 g of ketjen black (EC600JD, manufactured by Lion Corporation) having a specific surface area of 800 m²/g was added thereto. This mixture was stirred at 60° C. for 8 hours; and a precipitate was collected by filtration, washed with water and acetone and then dried in vacuo to obtain 0.72 g of a surface-modified carbon material (3). As a result of analysis using fluorescent X-rays, it was revealed that the surface-modified carbon material (3) contained 12.6% of a chlorine atom. Accordingly, it was noted that a chlorophenyl group was contained in an amount of 3.56 mmoles per gram of the surface-modified carbon material.

### Comparative Example 2

### Production of Surface-Modified Carbon Material (4) Using Diazonium Salt:

5.31 g of 4-chloroaniline was dissolved in 50 mL of water and 20 mL of concentrated hydrochloric acid, and the solution was cooled to 2° C. while stirring. A solution prepared by dissolving 2.87 g of sodium nitrite in 10 mL of water was added dropwise thereto, and the mixture was stirred at not higher than 5° C. for one hour. 0.50 g of DENKA BLACK (a 100% pressed product, manufactured by Denki Kakgaku Kogyo Kabushiki Kaisha) having a specific surface area of 66 m²/g was added thereto. This mixture was stirred at 60° C. for 8 hours; and a precipitate was collected by filtration, washed with water and acetone and then dried in vacuo to obtain 0.49 g of a surface-modified carbon material (4). As a result of analysis using fluorescent X-rays, it was revealed that the surface-modified carbon material (4) contained 3.6% of a chlorine atom. Accordingly, it was noted that a chlorophenyl group was contained in an amount of 1.01 mmoles per gram of the surface-modified carbon material.

### Example 3

As to Examples 1 and 2 and Comparative Examples 1 and 2, when the temperature was raised from room temperature to 550° C. at a rate of 10° C./min, thermo-gravimetric/differential thermal analysis (TG/DTA) was carried out in a nitrogen gas atmosphere having a purity of 99.99% or more. A weight loss (% by mass) at from 150 to 250° C. and a value obtained by dividing a weight loss (% by mass) by a specific surface area (m²/g) are shown in Table 1.

TABLE 1

| | Weight loss | Weight loss (% by mass)/ |
|---|---|---|
| | (% by mass) | specific surface area (m²/g) |
| Example 1 | 0.78 | 0.98 × 10⁻³ |
| Example 2 | 0.06 | 0.97 × 10⁻³ |
| Comparative Example 1 | 1.57 | 1.96 × 10⁻³ |
| Comparative Example 2 | 0.14 | 2.18 × 10⁻³ |

As is clear from Table 1, it was confirmed that as compared with Comparative Examples 1 and 2 in which the modification was carried out using a diazonium salt, Examples 1 and 2 are low in the weight loss per specific surface area (m²/g) and thermally stable in a region of from 150 to 250° C. These carbon materials can be used even at a high temperature as compared with existing surface-modified carbon materials, and superiority thereof was confirmed. The benzyne is an active species for forming two covalent bonds, and a modification group is bonded to the carbon surface via the two covalent bonds. Therefore, it is considered that as compared with the Comparative Examples in which bonding is achieved via single bond, the bonding is hardly separated at the time of heating, resulting in exhibiting superiority.

The present disclosure relates to the subject matter contained in Japanese Patent Application No. 253377/2007 filed on Sep. 28, 2007, which is expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A surface-modified carbon material, wherein a value obtained by dividing a weight loss (% by mass) by a specific surface area (m²/g) of the carbon material is not more than 1.5×10⁻³, the weight loss being a value when the temperature is raised from 150 to 250° C. at a rate of 10° C./min in a nitrogen gas atmosphere having a purity of 99.99% or more.

2. A surface-modified carbon material obtained by subjecting a carbon material to react with a benzyne.

3. The surface-modified carbon material as set forth in claim 2, wherein a value obtained by dividing a weight loss (% by mass) by a specific surface area (m²/g) of the carbon material is not more than 1.5×10⁻³, the weight loss being a value when the temperature is raised from 150 to 250° C. at a rate of 10° C./min in a nitrogen gas atmosphere having a purity of 99.99% or more.

4. The surface-modified carbon material as set forth in claim 2, wherein a value obtained by dividing a weight loss (% by mass) by a specific surface area (m²/g) of the carbon material is not more than 1.2×10⁻³, the weight loss being a value when the temperature is raised from 150 to 250° C. at a rate of 10° C./min in a nitrogen gas atmosphere having a purity of 99.99% or more.

5. The surface-modified carbon material as set forth in claim 2, wherein the benzyne is a compound represented by the following general formula (1). 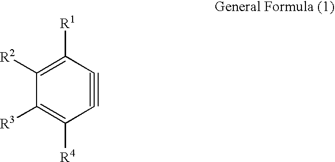
In the general formula (1), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; and X⁻ is a halide ion or an anion derived from a mineral acid or an organic acid.

6. The surface-modified carbon material as set forth in claim 2, wherein the benzyne is a compound generated from, as a precursor, a compound represented by the following general formula (2). 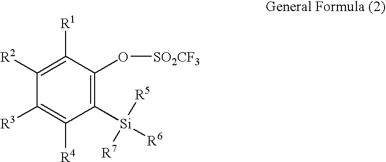
In the general formula (2), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; X⁻ is a halide ion or an anion derived from a mineral acid or an organic acid; and R⁵, R⁶ and R⁷, which may be the same or different, are each a hydrogen atom, an alkyl group, an alkenyl group, an alkynyl group, an aryl group, a heteroaryl group or an aralkyl group.

7. The surface-modified carbon material as set forth in claim 2, which comprises an organic group derived from the benzyne in amount of 0.1 mmoles or more per 1 g of the surface-modified carbon material.

8. The surface-modified carbon material as set forth in claim 2, which comprises an organic group derived from the benzyne in amount of from 0.2 to 5.0 mmoles per 1 g of the surface-modified carbon material.

9. The surface-modified carbon material as set forth in claim 2, wherein the carbon material is carbon black or carbon nanotube.

10. The surface-modified carbon material as set forth in claim 2, wherein the carbon material is carbon black.

11. The surface-modified carbon material as set forth in claim 2, wherein the specific surface area of the carbon material is from 20 to 1,000 m²/g.

12. The surface-modified carbon material as set forth in claim 2, wherein the specific surface area of the carbon material is from 60 to 800 m²/g.

13. A method for producing a surface-modified carbon material comprising subjecting a carbon material to react with a compound represented by the following general formula (1), 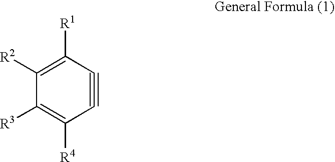
In the general formula (1), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; and X⁻ is a halide ion or an anion derived from a mineral acid or an organic acid.

14. The method for producing a surface-modified carbon material as set forth in claim 13, wherein a fluoride ion is exerted on a compound represented by the following general formula (2) to generate the compound represented by the general formula (1). 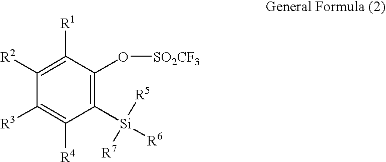
In the general formula (2), R¹, R², R³ and R⁴, which may be the same or different and may be connected to each other to form a ring, are each selected among functional groups selected from the group consisting of —R, —OR, —COR, —COOR, —OCOR, a carboxylate salt, a halogen atom, —CN, —NR₂, —SO₃H, a sulfonic acid salt, —NR(COR), —CONR₂, —NO₂, —PO₃H₂, a monobasic phosphonic acid salt, a dibasic phosphonic acid salt, —N═NR, —N₂⁺X⁻, —NR₃⁺X⁻, —PR₃⁺X⁻, —SR, —SO₂NRR′, —SO₂SR and —SO₂R; R and R′, which may be the same or different, are each a hydrogen atom, an alkyl group, an alkenyl group, an alkynyl group, an aryl group, a heteroaryl group or an aralkyl group; X⁻ is a halide ion or an anion derived from a mineral acid or an organic acid; and R⁵, R⁶ and R⁷, which may be the same or different, are each a hydrogen atom, an alkyl group, an alkenyl group, an alkynyl group, an aryl group, a heteroaryl group or an aralkyl group.

15. The method for producing a surface-modified carbon material as set forth in claim 13, wherein the surface-modified carbon material is a surface-modified carbon material which is obtained by subjecting a carbon material to react with a benzyne.

16. A catalyst-supported carbon material comprising a surface-modified carbon material and a metal catalyst supported thereon, wherein the surface-modified carbon material is obtained by subjecting a carbon material to react with a benzyne.

17. The catalyst-supported carbon material as set forth in claim 16, wherein the metal catalyst is platinum.

18. A membrane and electrode assembly comprising a porous conductive sheet and a catalyst layer provided in contact with the porous conductive sheet, the catalyst layer containing the catalyst-supported carbon material as set forth in claim 16.

19. A fuel cell comprising the membrane and electrode assembly as set forth in claim 18.
